(19) United States
(12) Patent Application Publication
(10) Pub. No.: US 2005/0044255 A1
(43) Pub. Date: Feb. 24, 2005

(54) Streaming image distribution system

(75) Inventor: Yasuo Yokoyama, Tochigi-ken (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: ONEI Ltd.

(21) Appl. No.: 10/894,133

(22) Filed: Jul. 20, 2004

(30) Foreign Application Priority Data
Jul. 21, 2003 (JP) 2003-302078
Sep. 22, 2003 (JP) 2003-368106
Jan. 26, 2004 (JP) 2004-48746

(51) Int. Cl. G06F 15/16; G06F 15/173

(52) U.S. Cl. 709/231; 709/219

(57) ABSTRACT

A streaming image distribution system which can distribute streaming images to many and unspecified viewers as well as specified viewers. The streaming image distribution system includes a distribution management server having distribution management data containing, through registration, channel numbers set for respective requesters requesting distribution of the streaming images, file names related to the streaming images to be distributed for respective channel numbers, identification codes, image distribution periods, addresses of the image distribution servers storing the streaming images provided with the respective filenames. Reception terminal apparatuses for users to enjoy streaming images, when requesting the distribution of streaming images, transmits the channel numbers and image identification codes to the distribution management server. A streaming image to be distributed to a specified viewer is requested to be distributed from the reception terminal apparatus of the viewer by means of the image identification code.

### BACKGROUND OF THE INVENTION

The present invention relates to a streaming image distribution system which distributes dynamic image as streaming image through the Internet.

The present application claims priority from Japanese Application Nos. 2003-302078, 2003-368106, 2004-048746, the disclosures of which are incorporated herein by reference for all purposes.

With the development of communication technology using the Internet in recent years, dynamic image data distribution system has been put into practical use in various fields. Such dynamic image data distribution system allows a user to operate at a reception terminal apparatus consisting of a personal computer connected with the Internet, to link an image distribution server storing dynamic image data (containing sound), so as to receive the linked dynamic image data and reproduce the same.

As a method of distributing a file containing sentences and image data, there has been traditionally and broadly in use a method of employing an e-mail software such as Outlook Express (Microsoft Corporation) to attach the file to an e-mail so as to transmit the same, as well as a method of using a homepage currently exhibited on the Internet to download the image data or the like. In the method of downloading such image data in the unit of a file, if the data capacity of a file is large, distribution time of data will have to be long. As a result, there is a problem that a user has to wait a long time for receiving and reproducing the data. In particular, when distributing dynamic image data containing sound, data capacity may be several 100 MB (megabyte), hence increasing the foregoing problem. In view of this, there have been suggested various improved systems to solve the above problem, such as those disclosed in Japanese Unexamined Patent Application Publication No. 2003-173316-(Pages 2-6, FIGS. 1 and 5), Japanese Unexamined Patent Application Publication No. 2002-230436 (Pages 2-5, FIGS. 1 and 2), Japanese Unexamined Patent Application Publication No. 2002-139986 (Pages 1-5, FIG. 1), Japanese Unexamined Patent Application Publication No. 2002-354451 (Pages 1-8, FIGS. 1, 2, and 3), and Japanese Unexamined Patent Application Publication No. 2003-230125 (Pages 2-6, FIG. 2).

Japanese Unexamined Patent Application Publication No. 2003-173316 discloses a dynamic image e-mail transmission system which is used for transmitting via e-mail dynamic images from a center server to user's information processing terminals. In this system, if a user's information processing terminal, after opening a dynamic image mail, outputs a request (for transmitting a dynamic image file) to the center server in accordance with a command described in the dynamic image mail, the requested dynamic image can be distributed via e-mail without adopting the form of an attached file in the e-mail.

Japanese Unexamined Patent Application Publication No. 2002-230436 discloses an Internet mail order system. In this system, when a user operates a reception terminal apparatus to get an access to the web page of the mail order system, once a distribution request button (or a page) of dynamic image data currently displayed on the web page is clicked with a mouse, an image distribution server will transmit the requested dynamic image data to the reception terminal apparatus, so that reception terminal apparatus can reproduce the received dynamic image data. Further, this patent publication discloses that an image distribution server carries Real System which is a software for transmitting streaming data, while the reception terminal apparatus carries Real Player which is a software for performing reception and playback of streaming data, thereby performing the distribution and playback of streaming image data.

Japanese Unexamined Patent Application Publication No. 2002-139986 discloses a school education supplementary lesson organization virtual learning environment offering system using the Internet. This system can distribute image data for use as lesson data by using participant's terminals as well as a server of an Internet Service Provider, and can be established at a low cost and within a short time period. Further, this patent publication discloses that the Internet Service Provider can perform an authentication in accordance with an exclusive account transmitted from a participant's terminal, thereby allowing the participant to make connection to the Internet. Moreover, this patent publication also discloses performing streaming image distribution.

Japanese Unexamined Patent Application Publication No. 2002-354451 discloses a streaming broadcast system equipped with an image distribution server which distributes streaming data by two or more channels. In this system, a program table and channels or the like are displayed on a user's reception terminal, and it is possible to automatically effect a connection with the Internet and a connection with the image distribution server by channel selection.

Japanese Unexamined Patent Application Publication No. 2003-230125 discloses a control method for automatically changing over streaming image distributions. In this system, when offering a service of distributing streaming images between a stream distribution server and an end host through the Internet, the end host is used to perform an evaluation on the quality of the streaming images being received. If it has been determined that the quality is low, the end host may be automatically connected to another stream distribution server capable of providing an optimal streaming image.

The dynamic image e-mail system disclosed in Japanese Unexamined Patent Application Publication No. 2003-173316 is formed such that when a user opens a received e-mail and uses a displayed page to send a request (for distributing a dynamic image file) to the center server, the center server will distribute the requested dynamic image file to the user's information processing terminal. Consequently, the situation will remain the same as a conventional e-mail system, i.e., the dynamic image file has to be distributed to the user's information processing terminal, presenting a problem that the user's information processing terminal needs considerable time in receiving the dynamic image file.

The Internet mail order system disclosed in Japanese Unexamined Patent Application Publication No. 2002-230436, a temporary storing server exhibits a web page on the Internet and at the same time holds as well as manages the image streaming data of each respective goods. However, the image streaming data stored in the server is subjected to frequent addition or deletion operation (file updating operation) in order to add new commercial products. In such a file updating operation, since it is necessary to change the display contents of a web page, it is necessary to temporarily stop the disclosing of the web page, hence lowering the trust of users (customers) in this service. In order to solve this problem, a server disclosing the web page and an image distribution server for storing and distributing image (dynamic image) data are required to be constituted separately from each other on the Internet. However, the compositions of such servers are not taught in Japanese Unexamined Patent Application Publication No. 2002-230436.

In the school education supplementary lesson organization virtual learning environment offering system using the Internet, as disclosed in Japanese Unexamined Patent Application Publication No. 2002-139986, the Internet Service Provider can perform an authentication in accordance with an exclusive account transmitted from a participant's terminal, thereby allowing the participant to make connection to the Internet. In such an Internet Service Provider, new registration and deletion operations of static image data, dynamic image data, and the like for distribution will have to be performed frequently on the server. However, Japanese Unexamined Patent Application Publication No. 2002-139986 teaches nothing about means for efficiently performing such new registration and deletion operations of dynamic image data and the like.

In the streaming broadcast system disclosed in Japanese Unexamined Patent Application Publication No. 2002-354451, a user can perform channel selection so as to automatically effect a connection from his or her reception terminal to the Internet, as well as to receive as streaming data the image data corresponding to a channel number. In this way, when a user selects a channel number, an expected effect may be obtained if streaming data to be distributed can be clearly classified into different genres such as news, music, and sports. However, when dynamic image data in specific fields, such as dynamic image data of various lecture meetings, and dynamic image data for education such as a coaching school and a correspondence education course, are distributed to specific users (affiliates) to whom respective authentication numbers have already been given in advance, there is no need for each user to select a channel number. Thus, it is desired to establish a system so formed that once a user's authentication number is sent to an image distribution server, the dynamic image data corresponding to this authentication number can be distributed to the user. This is because such a system requires a user to perform only a simple operation when he or she sends out a request for distribution, thus making it possible to simplify the composition of the software of an image distribution server.

In the control method for automatically changing over streaming image distribution as disclosed in Japanese Unexamined Patent Application Publication No. 2003-230125, an end post will need to carry a software for performing a quality evaluation at an application level on the stream image being received, from at least one of reception band, packet loss, display rate and the like. On the other hand, it is not necessary for an ordinary user to install a software for performing a quality evaluation on such streaming image reception in his or her personal computer which serves as a reception apparatus.

In recent years, with the progress of the Internet technology, especially with the development of high speed communication, there is an increasingly high demand for distributing, as streaming image, dynamic image containing sound to a viewer.

The reason for this situation may be concluded as follows.

1) Even if dynamic image data distributed in accordance with a streaming method is received by a reception terminal apparatus on a viewer's side, it is impossible for the received data to be accumulated as a file, thereby effective preventing an illegal copy.

2) There is an increasingly high demand for distributing, in the form of dynamic image, images of lecture meetings held by various societies and the like, images of research presentation meetings, PR images of enterprises or various associations, pictures of family members living in their home country which are to be transmitted to other family member (child) living far away (such as in a foreign country).

Distributing dynamic images as streaming images can be effected by an individual using his or her personal computer linked to the Internet, so that it is possible for an individual person to establish a dynamic image distribution system as one sort of business. For example, a distribution requestor (such as an enterprise, one of various schools and associations, an individual, etc.) for distributing dynamic images to viewers can specify a distribution period to an image distribution proprietor managing and running image distribution servers and the like so as to order distribution of dynamic images, while the image distribution proprietor can charge the distribution requestor for the dynamic image distribution performed.

When a system for distributing the above-mentioned streaming images is to be established, it is required that such a system should take into account whether the viewers of the streaming images are many and unspecified persons, or specified persons such as members of various societies or family members or the like. Further, such a system is required to ensure that a distribution requesting method for a viewer to request the distribution of streaming images as well as the distribution processing of a distribution management server can be effected appropriately depending on whether the viewers are many and unspecified viewers or specified viewers. This is because when the distribution is performed for transmitting images to many and unspecified viewers, a distribution requestor is required only to disclose a homepage (hereinafter, referred to as web page) containing the address of an image distribution server and image file names, so that a viewer is required only to use the web page to request the distribution of the streaming images.

On the other hand, when viewers are specified persons such as members of various societies, family members or the like, it is necessary to establish a streaming image distribution system which makes it impossible for a third party to decode the address of an image distribution server storing the streaming images to be distributed, as well as the file names of these streaming images.

### SUMMARY OF THE INVENTION

Therefore, it is an object of the present invention to provide an improved streaming image distribution system for distributing streaming images through the Internet, which system can perform an appropriate distribution and provide an increased economic interest to those running distribution management servers, irrespective of whether the dynamic images to be distributed in accordance with a requestor's instruction are transmitted to many and unspecified viewers or only to specified viewers.

According to the present invention there is provided a streaming image distribution system comprising: image distribution servers storing streaming images to be requested for distribution; a distribution management server having a distribution management data table containing, through registration, channel numbers set for respective distribution requestors requesting distribution of the streaming images, file names related to the streaming images to be distributed for respective channel numbers, distribution periods, addresses of the image distribution servers storing the streaming images; and reception terminal apparatuses of viewers for requesting distribution of the streaming images and viewing the streaming images. Specifically, the distribution management data table has included, through registration, image identification codes for performing transmission from the reception terminal apparatuses to the distribution management server, in a manner such that only specified viewers can request distribution of streaming images provided with the channel numbers. In particular, the reception terminal apparatuses are provided with distribution request transmission means which, in requesting distribution of the streaming images, transmits the channel number or image identification code to the distribution management server.

In one aspect of the present invention, the distribution request transmission means is means for transmitting the channel number or the image identification code to the distribution management server through a web page disclosed by the distribution requestor or a proprietor of the distribution management server.

In another aspect of the present invention, the distribution request transmission means is means for transmitting the channel number or the image identification code by HTML mail to the distribution management server.

In a further aspect of the present invention, the distribution request transmission means is means for transmitting a recognition number, consisting of an identification number for identifying a viewer and a channel number, to the distribution management server, through a web page disclosed by the distribution requestor or a proprietor of the distribution management server.

In a still further aspect of the present invention, the distribution request transmission means is means for transmitting a recognition number, consisting of an identification number for identifying a viewer and a channel number, to the distribution management server, by means of HTML mail.

In one more aspect of the present invention, the distribution management server comprises: first streaming image distribution means which, upon receiving a channel number from the distribution request transmission means of the reception terminal apparatus, refers to data within the distribution period registered in the distribution management data table about the received channel number, finds the file name of a streaming image where a date on which the distribution request was received is contained in the distribution period, also finds the address of the image distribution server, and performs a control on the image distribution server for distributing a streaming image provided with the file name to the reception terminal apparatus; and second streaming image distribution means which, upon receiving an image identification code from the reception terminal apparatus, refers to data within the distribution period registered in the distribution management data table about the received image identification code, finds the file name of a streaming image where a date at which the image identification code was received is contained in the distribution period, also finds the address of the image distribution server, and performs a control on the image distribution server for distributing a streaming image provided with the file name to the reception terminal apparatus.

In one more aspect of the present invention, the streaming image distribution system further comprises a terminal apparatus of the distribution requester, which apparatus includes means for uploading to the distribution management server a streaming image requested by the distribution requestor for distribution.

In one more aspect of the present invention, the proprietor of the distribution management server is a system which rents the channel number to the distribution requestor.

The streaming image distribution system of the present invention can provide the following advantages.

1) The streaming images to be distributed can serve all viewers according to the requests of a distribution requester, regardless of whether the viewers are many and unspecified persons or only specified persons. Especially, the streaming images distributed to specified viewers such as members of various societies and family members can be prevented from being viewed by many unspecified viewers. In this way, it is possible to establish a system capable of ensuring a security for a distribution request from an individual person who wishes to distribute streaming images only to his or her family members living far away.

2) Since the program processing of the distribution management server performing the processing mentioned in the above 1) can be implemented with reference to the distribution management data table registered in advance in the distribution management server, it is possible to form an extremely simple program composition for the distribution management server.

3) A proprietor running the distribution management server is allowed to increase its economic interest by renting a channel number set for a distribution request or to the distribution requestor. Furthermore, by concluding a contract for distributing streaming images between a distribution requestor and specified viewers, it is possible to establish a streaming image distribution system which allows the distribution requestor to obtain satisfactory economic interest.

### BRIEF DESCRIPTION OF THE DRAWINGS

These and other objects and advantages of the present invention will become clear from the following description with reference to the accompanying drawings, wherein:

FIG. 1 is an explanatory view showing an example of a system constitution formed according to the present invention;

FIG. 2 is an explanatory view showing an example of a data composition of a distribution management data table registered in a distribution management server;

FIG. 3 is an explanatory view showing an example of an input form for inputting an image identification code, which is for use when a viewer requests the distribution of a steaming image through a reception terminal apparatus;

FIG. 4 is an explanatory view showing an example of a web page, which is for use when a viewer requests the distribution of a steaming image through the web page;

FIG. 5 is an explanatory view showing an example of a web page, which is for use when a viewer uses the web page to input an image identification code to request the distribution of a steaming image;

FIG. 6 is a flowchart showing a procedure of an operation for a viewer to request the distribution of a streaming image from a reception terminal apparatus;

FIG. 7 is a flowchart showing a procedure of an operation for a viewer to input an image identification code to request the distribution of a streaming image from a reception terminal apparatus;

FIG. 8 is an explanatory view showing the composition of a distribution management server;

FIG. 9 is a flowchart showing an example of a procedure of a distribution management program equipped in the distribution management server;

FIG. 10 is an explanatory view showing an example of an operation screen when a distribution requestor uploads a streaming image data requested by him or herself for distribution;

FIG. 11 is an explanatory view showing an example of a distribution menu of streaming images currently disclosed on the web page;

FIG. 12 is an explanatory view showing an example of a distribution request form for distributing streaming images disclosed on the web page;

FIG. 13 is an explanatory view showing an example of the data composition of an authentication number;

FIG. 14 is an explanatory view showing an example of an authentication number input form for use when inputting an authentication number to request a distribution; and

FIG. 15 is an explanatory view showing an example of the data composition of an authentication number data table.

### DETAILED DESCRIPTION OF THE PREFERRED EMBODIMENTS

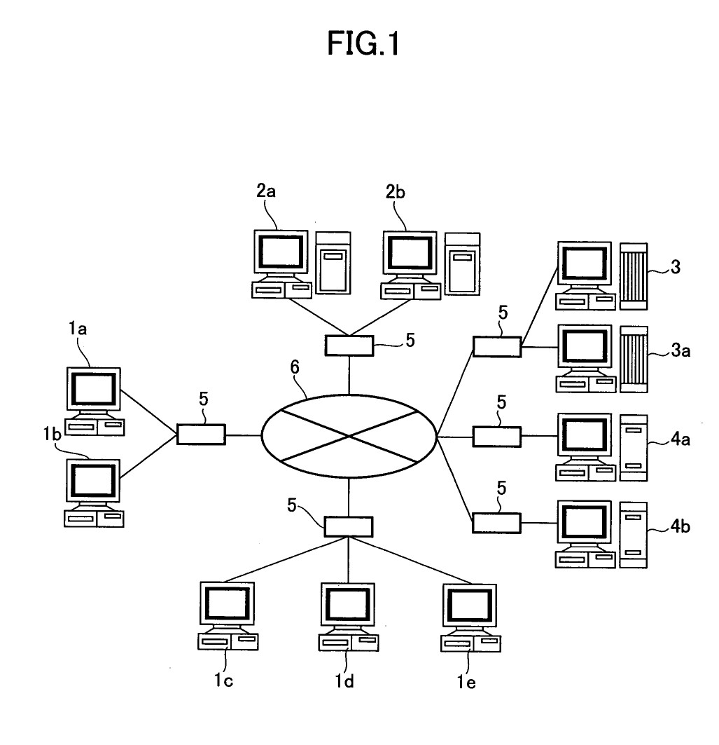

In the following, description will be given to explain the best mode for carrying out the present invention. FIG. 1 is an explanatory view showing an example of the constitution of a system for carrying out the present invention. In FIG. 1, 1a, 1b, 1c, 1d, 1e, . . . represent reception terminal apparatuses located on viewer's side for requesting the distribution of streaming images and reproducing (viewing and listening) the same by using the system of the present invention. Each of the reception terminal apparatuses 1a, 1b, 1c, id, le, . . . is composed of a personal computer which has in advance contained not only an os (Operating System) such as windows (Microsoft Corporation), but also Internet Explorer (Microsoft Corporation) which is a software (web browser) for viewing web pages, Outlook Express (Microsoft Corporation) which is an e-mail software, Windows Media Player (Microsoft Corporation) or Real Player (Real Networks Corporation) which is a software for receiving the data of streaming image distributed from the image distribution server and for reproducing the same.

In FIG. 1, 2a, 2b, . . . represent web servers each consisting of a personal computer or a work station. Specifically, each of the web servers 2a, 2b, . . . is a server run and managed by an enterprise, one of various associations, or an individual person disclosing web pages on the Internet. In the present invention, an enterprise or an individual person running the web servers 2a, 2b, . . . is a distribution requestor who sends a streaming image distribution request to a proprietor running the distribution management servers (hereinafter, referred to as distribution proprietor) which will be described later. Similarly, the web servers 2a, 2b, . . . have in advance contained the above-described software including OS (Operating System), web browser, e-mail software, and the like. Here, although only two sets of web servers 2a and 2b are shown in FIG. 1, it is also possible for many distribution requestor's web servers to join the system of the present invention if there are contracts concluded between parties concerned, as will be described later.

In FIG. 1, the reference numeral 3 represents a distribution management server consisting of a personal computer or a work station, which is managed and run by the aforementioned distribution proprietor. Specifically, the distribution management server 3 is a server for carrying out processing and managing in order to receive a streaming image distribution request from the reception terminal apparatuses 1a, 1b, . . . of the viewers and then distribute the data of the requested streaming image to the reception terminal apparatuses 1a, 1b, . . . .

In more detail, the distribution management server 3 is equipped with a software section containing the above-described web browser, e-mail software, a software for converting image data picked-up by a video camera into streaming data, a software for uploading the converted streaming image data to an image distribution server, and a distribution management program for controlling the reception of distribution request and the processing of distribution. Furthermore, the distribution management server 3 is equipped with a standard data table (database) consisting of various standard data to be referred to when these software performs distribution processing, as well as a streaming image backup unit for storing as a backup the streaming image data to be distributed in case of an unexpected accident happening. The streaming image backup unit is composed of streaming image data stored (accumulated) in an external storage device such as a hard disc and provided with file names.

As shown in FIG. 1, the system includes the distribution management server 3 which is run by a distribution proprietor, receives a distribution request, and performs distribution processing. Further, it is also possible to provide the aforementioned streaming image backup unit in an image distribution server 3a. . . .

4a, 4b, . . . represent image distribution servers each consisting of a personal computer or a work station, run by the above-mentioned distribution proprietor or a third party. As an example of the servers 4a, 4b, . . . run by a third party, there may be servers owned by an ordinary enterprise, an Internet service provider, one of various associations, or an individual person. Namely, when there are some unused portions in the capacities of these web servers 4a, 4b, . . . a distribution proprietor can rent parts of external storage devices (hard disc devices) forming the servers, and then let the external storage devices to store streaming image data to be transmitted, thereby making it possible to use the external storage devices as image distribution servers, i.e., as rental servers. By virtue of such system constitution, a distribution proprietor does not have to carry out a high cost equipment investment in the image distribution servers 4a, 4b, . . . or the like, but is allowed to disperse the streaming image data to be distributed in the image servers 3, 3a, . . . run by him or her self, as well as in the servers 4a, 4b, . . . run by a third party. In this way, even if some sort of trouble happens in one of the image distribution servers 4a, 4b, . . . , such trouble can be removed quickly by uploading the backed-up streaming image data to the image distribution server working promptly and normally.

The above-mentioned viewer's reception terminal apparatuses 1a, 1b, 1c, 1d, 1e, . . . , distribution requestor's web servers 2a, 2b, . . . , distribution proprietor's distribution management server 3 and the backup server 3a, as well as the image distribution servers 4a, 4b, . . . of a distribution proprietor or a third party, are connected, through the Internet service providers 5 of respective places, to the Internet 6 which is a communication network.

Fundamentally, the streaming image distribution system of the present invention is such that a distribution requestor running the web servers 2a, 2b, . . . and an enterprise or an individual person who does not hold servers can entrust a distribution proprietor with the streaming image distribution. Such streaming image may, for example, be dynamic image (containing sound) picked up by a distribution requestor, or dynamic image owned by the distribution requestor. As more detailed examples, there may be dynamic image for PR of an enterprise and various associations, dynamic image picked up in research presentation meetings and lecture meetings of various societies, dynamic image for explaining exemplary answers to exercises in a school or a coaching school, and dynamic image of family recent state to be distributed to other family members or friends living far away (or in a foreign country).

Furthermore, the streaming image distribution system of the present invention is characterized in that it can properly distribute requested streaming image, irrespective of whether viewers of streaming image are many and unspecified persons or only specified persons such as members of various societies and family members, depending on the request of a distribution requester. However, when establishing and operating the system of the present invention, it is necessary to in advance complete the following matters as described below.

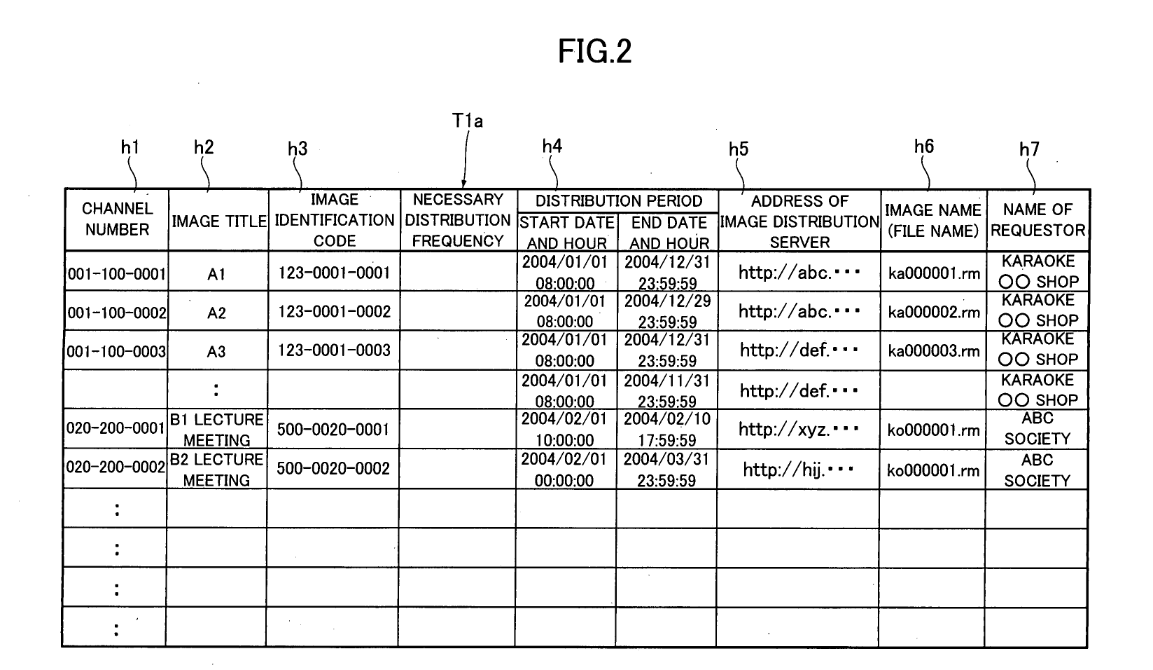

1) At first, a distribution requestor concludes a contract on streaming image distribution with a distribution proprietor performing the distribution of streaming image. The contents of the contract may include a distribution period, a distribution method specifying streaming image viewers which may be unspecified persons (open) or specified persons (non-open), and schedule of fees. Here, a distribution period indicates related dates specifying that requested images should be distributed from when to when. Then, the distribution proprietor, as being able to obtain a payment (rental charge) from a distribution requestor, assigns a right number to the distribution requester, indicating that the streaming image distribution has been requested, i.e., assigns a channel number (constituting the present invention) to each distribution requestor. Such channel number is a number set for the name of each streaming image (file name) required to be distributed in accordance with the request of a distribution requester, and consists of numbers or alphabetic characters which have a predetermined number of digits, set in the form of serial numbers such as “001” or “002.” Further, such channel number serves as an effective management number useful during a period prescribed by the contract on the streaming images whose distribution has been requested by a distribution requestor, and is registered in advance into a distribution management data table T1a (shown in FIG. 2) of the distribution management server 3, corresponding to the file names of streaming images requested for distribution. Moreover, a distribution proprietor can also clearly indicate in a distribution contract with a distribution requester that such channel number has already been provided to a distribution requestor.

Furthermore, it is also possible for a distribution proprietor to assign two or more channel numbers to one distribution requestor. If two or more channel numbers are assigned to one distribution requestor, it is possible to simultaneously distribute two or more sorts of streaming images requested by the distribution requestor. In this way, since the streaming image distribution system of the present invention has been formed such that a distribution requestor can request a distribution proprietor to distribute streaming images, it is possible to build a business in which a distribution proprietor, according to its contract with the distribution requestor, can rent a channel number assigned to a distribution requestor to the distribution requestor during a predetermined distribution period, thereby obtaining a corresponding rental income.

2) A distribution requestor himself (or herself) uses a digital video camera to pick up dynamic images which he or she wishes to distribute. Alternatively, the distribution requestor requests a distribution proprietor or a third party to pick up the dynamic images. Then, the distribution requester provides a distribution proprietor with cassette tapes having recorded therein the dynamic images. As objects to be picked up as the dynamic images, there may be dynamic images containing sounds of various fields, such as images of lecture meetings of various societies, images of trainings conducted by a coaching school as supplementary lessens, images about how to do exercises, images for introducing new technology and new products of an enterprise and various associations, and images of recent state of family members.

3) A distribution proprietor, upon receiving the cassette tapes having recorded therein dynamic images from a distribution requestor, digitizes the dynamic image data if necessary, and then converts the digitized data so that the date can be distributed as streaming image data, followed by storing the converted data in an external storage device such as the distribution management server 3. As software for converting the above data into the streaming image data, it is possible to use Windows Media Encoder (Microsoft Corporation) or the like.

4) Once the above processing 3) is finished, the distribution proprietor prepares and registers the distribution management data (data table) T1a shown in FIG. 2 into the distribution management server 3. Distribution management data table T1a is a database which has registered the addresses (URL) of the image distribution servers 4a, 4b, . . . on the Internet, a distribution period, and image identification codes, etc. Here, the image distribution servers 4a, 4b, . . . have stored (accumulated) therein, for the purpose of distribution, the title names and the file names of the streaming images whose distributions have been requested by a distribution requestor, and the streaming images having these file names, with respect to each channel number assigned (set) to the above distribution requestor. Thus, such distribution management data table T1a serves as a database which can be referred to at the time a distribution management program of the image management server 3 performs, through program processing, a control of distribution processing on the image distribution servers 4a, 4b, . . . when a streaming image distribution request has been transmitted to the image management server 3 from the reception terminal apparatuses 1a, 1b, . . . on viewer's side.

Specifically, the distribution management data table T1a has stored, as shown in FIG. 2, various data related to items including channel number h1, image title h2, image identification code h3, distribution period h4, addresses (URL) h5 of the image distribution servers 4a, 4b, . . . having stored (accumulated) the data of streaming images to be distributed, file names h6 of the streaming images, and names h7 of distribution requestors. Among these items, an image title h2 registers titles which a distribution requester or a distribution proprietor has provided, while a distribution period h4 registers distribution start date and end date.

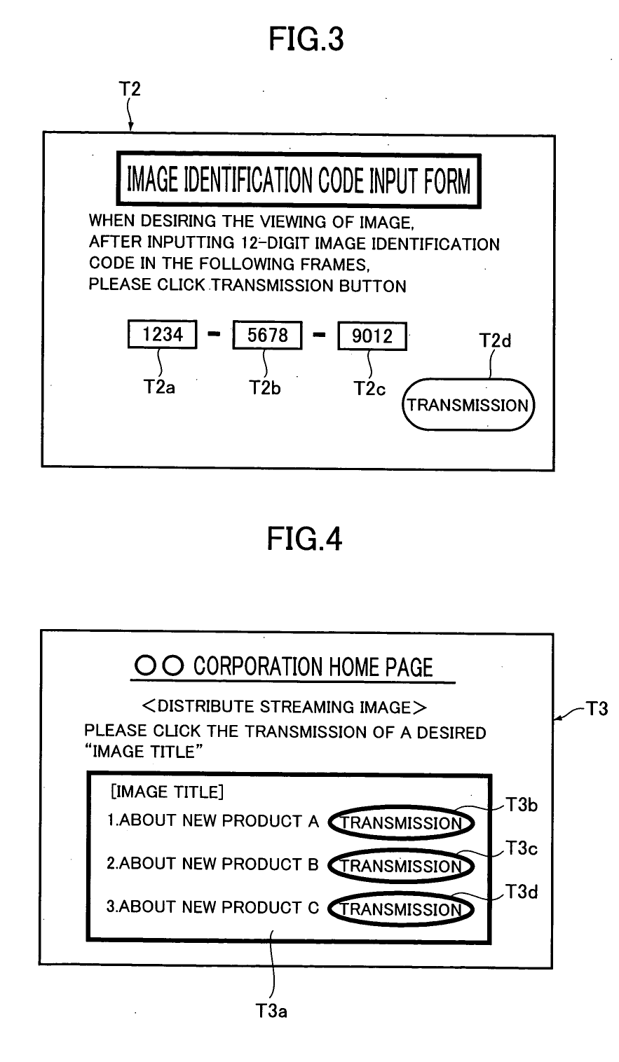

In addition, each image identification code h3 registered in the distribution management data table T1a is a code registered in advance when a streaming image requested to be distributed by a distribution requestor is distributed to a specified viewer in accordance with the request of the distribution requester. Here, each image identification code h3 consists of a predetermined number of digits, for example, 10-16 digits of a number or alphanumeric characters, with the first 4-6 digits constituting a distribution requestor's attribute portion having coded the distribution requestor's country, area, association, and enterprise name, but with the remaining digits constituting a number including an additional number or a random inherent number. Moreover, when it is necessary to assign a random number to the number portion, it is also possible to provide a program which generates a random number in the distribution management server 3, thereby making it possible to automatically set a random number portion having a predetermined digits by making use of such random number generation program. A distribution proprietor, upon setting an image identification code h3, uses an ordinary mail or HTML mail to inform a distribution requestor (who has sent out a request for distributing a streaming image assigned with an image identification code h3) of the set channel number h1, image identification code h3, and the like. When using HTML mail to notify a distribution requestor of an image identification code h3, it is also allowed to transmit to the distribution requestor the data of an image identification code h3 set together with an image identification code input form T2 as shown in FIG. 3. Accordingly, each image identification code h3 is an inherent code number set up for every streaming image to be distributed to a specified viewer.

5) A proprietor of the distribution management server 3 performs an operation of uploading the image data (converted in the above processing 3) so that it can be distributed as streaming image data) into URLs h5 of the image distribution servers 4a, 4b, stored in the distribution management data table T1a. The image distribution server for uploading the streaming image data, as described above, can be stored not only in the server 3a owned by the proprietor of the distribution management server 3, but also separately in other rental servers 4a, 4b, . . . connected to the Internet.

6) When a distribution requestor wishes to distribute streaming images to many and unspecified viewers according to a contract with a distribution proprietor, the distribution requestor can exhibit a web page T3 shown in FIG. 4 on the Internet 6, using the web servers 2a, 2b, . . . or the like. The web page T3 shown in FIG. 4 is prepared in the HTML language, and is equipped with a window frame T3a for a viewer to request the distribution of streaming image. Once a viewer clicks (with a mouse) any one of transmitting buttons T3b, T3c, and T3d provided for respective image titles displayed in the window frame T3a, the streaming image corresponding to the transmission button T3b, T3c, or T3d will be distributed to the reception terminal apparatuses 1a, 1b, . . . of viewers. A method of requesting the distribution of streaming image shown in FIG. 4 constitutes the distribution request transmission means based on the channel numbers according to the present invention. However, in the present invention, web page T3 shown in FIG. 4 also includes a case where not only a distribution requestor but also a third party who has received a request from the distribution requestor will disclose information on the Internet 6.

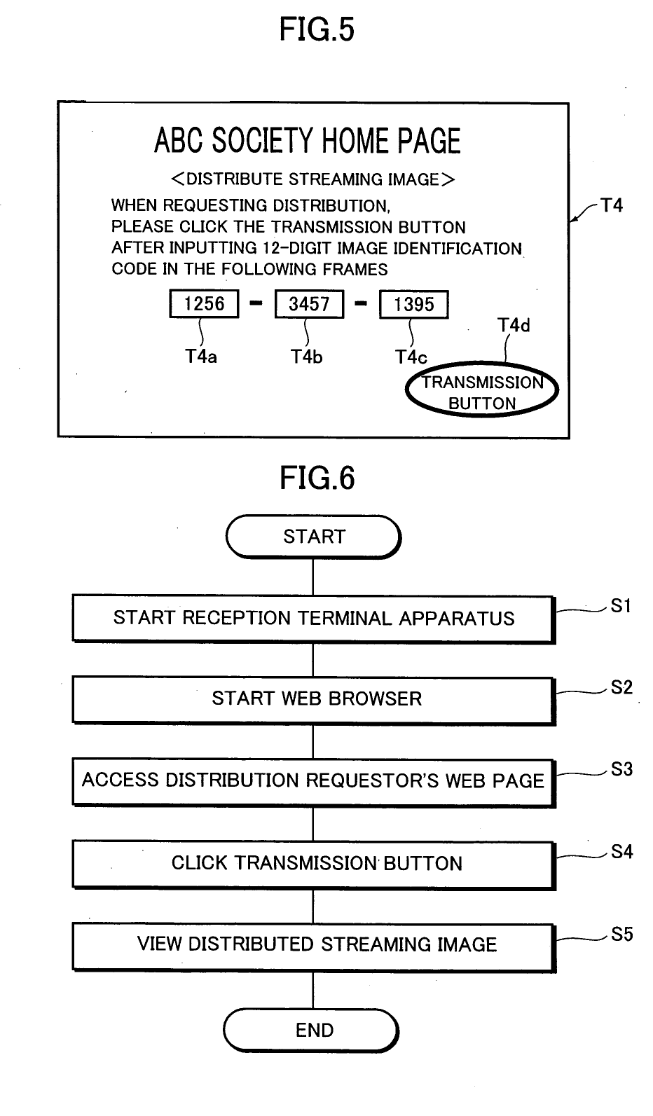

7) On the other hand, when a distribution requestor distributes streaming images to specified viewers according to a contract with a distribution proprietor, the distribution request or can use e-mail or the like to inform the reception terminal apparatuses 1a, 1b, . . . of the viewers (requesting the distribution of the streaming images) of the image identification codes h3 which have received communications from the distribution proprietor via e-mail or the like. However, a method of communicating the image identification codes h3 can be realized not only by e-mail, but also by sending documents or the like to the members of various societies if the distribution requestors are organizations of various societies and the like. Moreover, a distribution requestor is also allowed to use a web page exhibited by the distribution requestor on the Internet 6, to send a streaming image distribution request to a specified viewer. At this time, a web page T4 as shown in FIG. 5 is exhibited, and image identification codes each consisting of a predetermined number of digits are successively inputted into input frames T4a, T4b, and T4c. Then, a transmission button T4d is clicked with a mouse so that the inputted image identification codes are transmitted to the distribution management server 3.

8) Further, when a distribution requestor distributes streaming images to specified viewers according to a contract with a distribution proprietor, a specified viewer is allowed to use means formed such that after image identification codes are inputted into the input frames T2a, T2b, and T2c of the image identification code input form T2 transmitted by HTML mail and shown in FIG. 3, the transmission button T2d is clicked so that the inputted image identification codes are transmitted via HTML mail to the distribution management server 3. Thus, a method of inputting and transmitting the image identification codes, shown in FIGS. 3 and 5, constitutes the distribution request transmission means based on the image identification codes according to the present invention.

Next, description will be given to explain an operation procedure for a viewer to use the reception terminal apparatuses 1a, 1b, . . . to request the distribution of streaming image and view the streaming image, as well as to explain the contents of processing of the system according to the present invention.

When a distribution requestor wishes to distribute streaming images to many and unspecified viewers, an operation procedure shown in FIG. 6 can be used for a viewer to view the streaming images on the reception terminal apparatuses 1a, 1b, . . . and the like.

At first, a viewer starts reception terminal apparatuses 1a, 1b, . . . or the like (Step S1), and then starts a web Browser such as Internet Explorer (Microsoft Corporation) (Step S2). Subsequently, the screen of the web Browser is used to access the web page of the distribution requester disclosing the web page for requesting the distribution of streaming images (Step S3). Here, a method of accessing a web page can be realized by using a known method which uses the screen of the web Browser to input a distribution requestor's URL and transmit the same.

Once a distribution requestor's web page is accessed, this distribution requestor's web page will be displayed on the screens of the reception terminal apparatuses 1a, 1b, . . . and the like. Disclosed in this web page is a page T3 for requesting the distribution of streaming image, as shown in FIG. 4. Then, titles of one or more streaming images to be distributed and the transmission buttons T3b, T3c, T3d, . . . are displayed in the window frame T3a. Afterwards, if a viewer clicks (with a mouse) any one of the transmission buttons T3b, T3c, T3d, . . . corresponding to the titles selected from the titles of streaming images (Step S4), a request for distributing such streaming image will be transmitted to the distribution management server 3 through the web page T3. In addition, web page T3 shown in FIG. 4 may also be displayed as a distribution schedule table including distribution period or the like for every title of streaming images.

Once a request for distributing a viewer's desired streaming image is transmitted to the distribution management server 3 through the processing in the above-mentioned Step S4, the distribution management server 3 will refer to the distribution management data table T1a, check a distribution period, search for the addresses and the filenames of the image distribution servers 4a, 4b, storing the streaming images requested to be distributed, and distribute the searched streaming image to the reception terminal apparatuses 1a, 1b, . . . of the viewers who have requested such distribution. Then, once viewer's reception terminal apparatuses 1a, 1b, . . . receive streaming images, Windows Media Player (Microsoft Corporation) which is the software for reproducing streaming images, or Real Player (Real Networks) will be actuated so that a viewer can view the streaming images (Step S5).

As indicated in the above-mentioned Steps S1-S5, when a distribution requester wishes to distribute streaming images to many and unspecified persons, the HTML language which created web page T3 of a distribution requestor as shown in FIG. 4, contains, for each of image titles being displayed, the address of the distribution management server 3 and the channel number h1 registered in the distribution management data table T1a of the distribution management server 3. Once a viewer clicks (with a mouse) any one of transmission buttons T3b, T3c, T3d, . . . , the address and the channel number of this distribution management server will be transmitted to the distribution management server 3. A distribution management program of the distribution management server 3 refers to the distribution management data table T1a, uses a received channel number to link (search) the file name of a streaming image to be distributed, as well as the addresses of the image distribution servers 4a, 4b, . . . storing the data of the file name, thereby distributing the linked streaming image to the reception terminal apparatuses 1a, 1b, . . . which have sent out a distribution request. In the HTML language which produces web page T3 for the above-mentioned distribution requester to send out a distribution request, there are embedded the following descriptions containing the address of a distribution management server as well as a channel number.
Open (‘http://www.stream.co.jp/ . . . ch=‘5’ . . . width=230, height=280’)

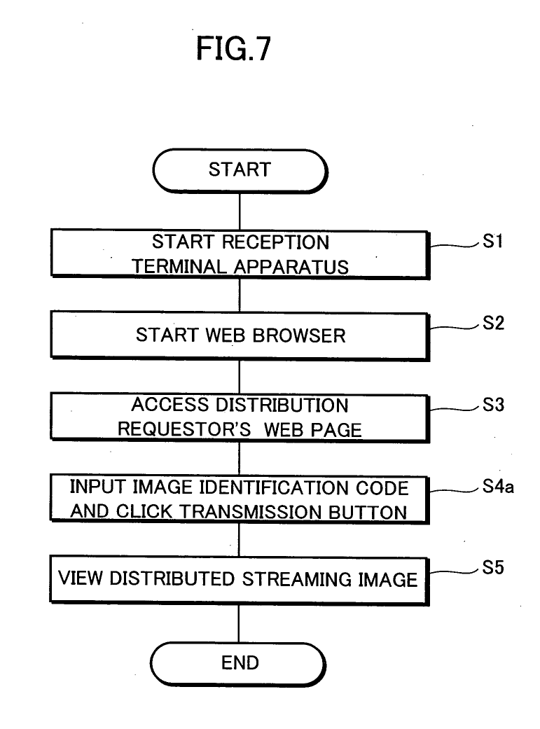

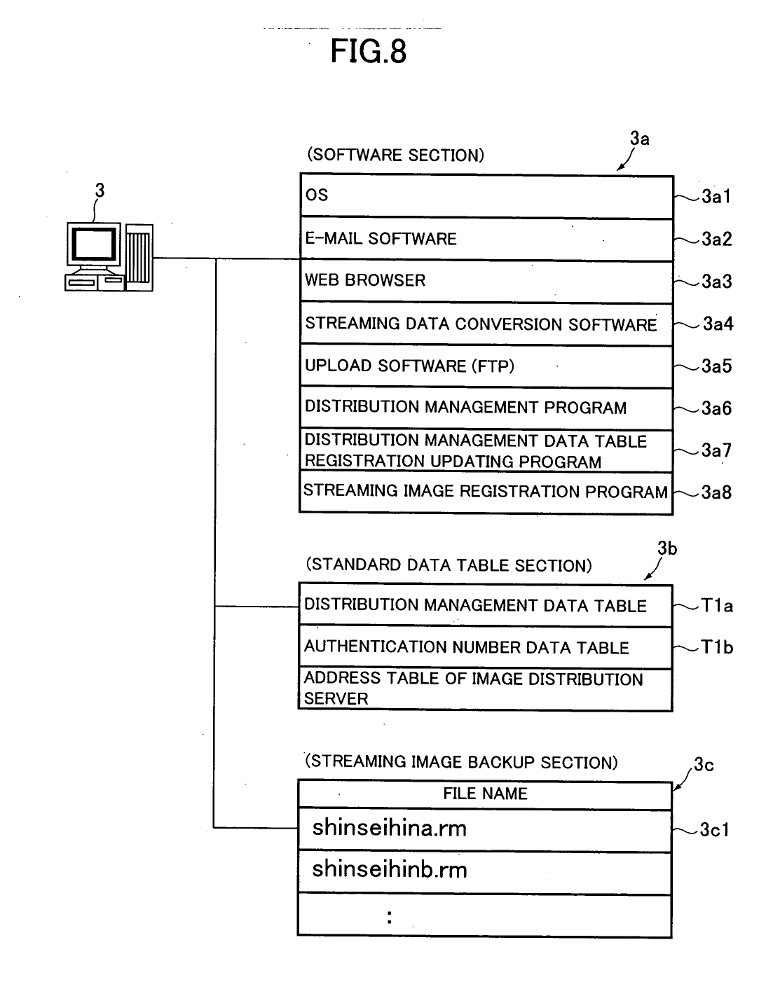

In this way, when a streaming image is distributed to many and unspecified persons, even if the address of a distribution management server as well as a channel number (which is “5” in the above-discussed example) are described in the HTML language of web page T3, a security problem will not occur in the distribution of streaming image. This is because the servers storing the data of the streaming images to be distributed are image distribution servers 4a, 4b, . . . which are independent and different from the distribution management server 3, and further, the distribution management server 3 performs a distribution instruction control on the image distribution servers 4a, 4b, Then, when a distribution requestor wishes to distribute a streaming image to specified viewers, it is allowed to use, as an example, a procedure shown in FIG. 7 which can be employed by specified viewers to operate the reception terminal apparatuses 1a, 1b, . . . and to request image distribution. This procedure differs from the procedure shown in FIG. 6 (which is for distributing images to many and unspecified viewers) in that it includes a Step S4a which will be described in the following.

In Step S4a, a web page accessed by a viewer, like the web page T4 shown in FIG. 5, exhibits a form for inputting, when requesting the distribution of streaming image, the image identification codes h3 registered in advance in the distribution management data table T1a corresponding to streaming images. The viewer, in accordance with an input form of web page T4, inputs image identification codes each having a predetermined number of digits in the input frames T4a, T4b, and T4c, followed by clicking (with a mouse) the transmission button T4d, so as to send the inputted image identification codes to the distribution management server 3.

As described above, when a distribution requestor has sent out a request for distributing a streaming image to a specified viewer, an image identification code h3 will be a number which is set with respect to the streaming image and registered in the distribution management data table T1a by a distribution proprietor and is communicated through a distribution requestor to a specified viewer by way of e-mail or printed materials. Therefore, since such an image identification code h3 is a number which can be known only by a specified viewer such as a member of various associations and societies or family members, the streaming image provided with the image identification code h3 can be distributed only to a specified viewer knowing the image identification code.

By virtue of processing in the above-mentioned Step S4a, once an image identification code h3 is transmitted from a viewer's reception terminal apparatus to the distribution management server 3, the distribution management server 3 will refer to the distribution management data table T1a, so as to check whether the transmitted image identification code h3 has been in advance registered in the distribution management data table T1a. If the transmitted image identification code has been registered in the distribution management data table T1a, checking will be performed to confirm whether the date and hour at which distribution was requested are contained in a distribution period h4 stored for each image file name h6 provided with this image identification code h3. In case where the date and hour at which distribution was requested are contained in the distribution period h4, the image identification code h3 is used to link the URLs (address) h5 of the image distribution servers 4a, 4b, . . . storing the file name h6 of the streaming image registered in the distribution management data table T1a and to be distributed, as well as the streaming image provided with the file name h6, so as to distribute, in accordance with the image identification code h3, the streaming image requested for distribution to the reception terminal apparatuses 1a, 1b, . . . .

Therefore, the reception terminal apparatuses 1a, 1b, . . . of viewers, upon receiving the streaming image requested for distribution, will operate to start Windows Media Player (Microsoft Corporation) which is a software for reproducing a streaming image, or Real Player (Real Networks), so that a viewer can view the streaming image (Step S5).

Next, description will be given to explain a processing procedure for dealing with a distribution request of the distribution management server 3. As mentioned above, the distribution management server 3 is composed of a personal computer or a work station. Further, as shown in FIG. 8, the distribution management server 3 comprises a software section 3a consisting of various kinds of software, a standard data table section 3b storing standard data to be referred to when executing such software, a streaming image backup section 3c for assigning file names to all the streaming image data to be distributed and storing the same as backup in the external storage device such as a hard disk. However, the streaming image data stored in the streaming image backup section 3c of the distribution management server 3 may be dispersed and stored in image distribution servers 3a, . . . , web servers 4a, 4b, . . . or rental servers, all actually performing distribution with respect to a distribution request. In this way, if, in the event of an accident, some troubles happen in any one of image distribution servers 3a, . . . and the web servers 4a, 4b, . . . , the data of streaming image and the data of streaming image file name stored in a server in which trouble has happened, will be uploaded from the streaming image backup section 3c to other web servers 4a, 4b, . . . , followed by correcting URL h5 of the image distribution server registered in the distribution management data table T1a, thereby removing the trouble within a short period of time.

Almost all of various software constituting the software section 3a are stored in the external storage device such as the hard disc device of the distribution management server 3, and read in a principle storage device when executing the program. Further, each data table constituting the standard data table section 3b is provided with a file name and stored in the external storage device, and read in a principle storage device when executing the program. Moreover, the data of streaming image converted into the streaming data for distribution is provided with a file name 3cl and stored in the streaming image backup section 3c, with its storage area ensured in the external storage device.

The software section 3a comprises, as shown in FIG. 8, an OS (Operating System) 3a1 serving as a basic software for operating the distribution management server 3, a web browser 3a2 for exhibiting a web page on the Internet, an e-mail software 3a3, a streaming data conversion software 3a4, a software (FTP) 3a5 for uploading streaming image data to the image distribution servers 4a, 4b, . . . , a distribution management program 3a6 for controlling the distribution request reception processing and the distribution processing on the streaming image data stored in the image distribution server 3a, . . . , and the image distribution servers 4a, 4b, . . . , a program 3a7 for registering and updating the distribution management table data, and a program 3a8 for registering streaming image, and the like.

The standard data table section 3b is a data table (database) storing the standard data to be referred to when each program of the software section 3a executes its processing, and is composed of the above-mentioned distribution management data table T1a, the authentication number data table T1b, and the like.

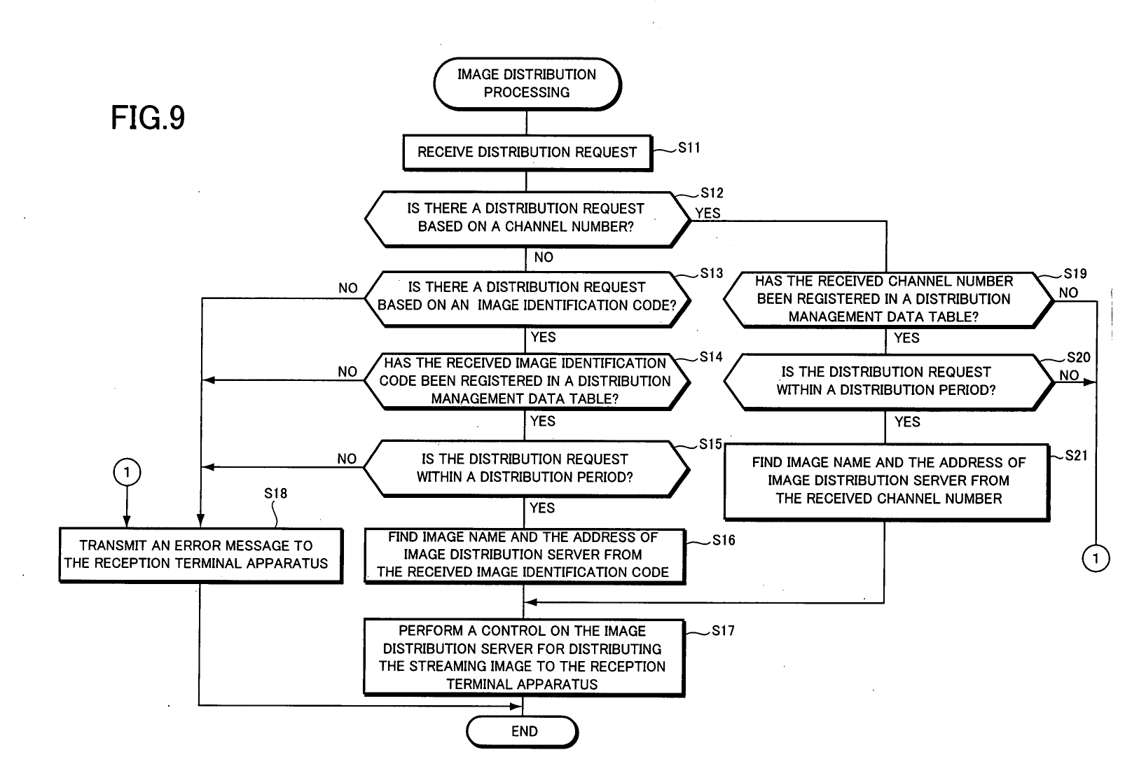

Now, description will be given, with reference to FIG. 9, to explain a processing procedure of the distribution management program 3a6 which can be executed when the distribution management server 3 has received a streaming image distribution request from the reception terminal apparatuses 1a, . . . . In fact, such a distribution management program 3a6 can be prepared by using HTML, or Perl which is a CGI script language for compensating for HTML, or by using Visual Basic, C language, or the like.

(Step S11)

Once the distribution management server 3 receives a streaming image distribution request data from the reception terminal apparatuses 1a, 1b, . . . by virtue of the above-mentioned distribution request transmission means, the distribution management program 3a6 will analyze whether the distribution request is a distribution request based on a channel number h1, or a distribution request based on an image identification code h3. As described above, when a streaming image distribution request is transmitted from the reception terminal apparatuses 1a, 1b, . . . , the data related to a channel number h1 or an image identification code h3 will be transmitted to the distribution management server 3 in accordance with web pages T2 and T4 and the image identification code input form T2. For example, when images are to be distributed to many and unspecified viewers, the HTML language describing the address of the distribution management server 3 and a channel number (ch) as indicated in the following expression (1) will be embedded in the web page T3. The following expression (1) indicates that a channel number “001” will be transmitted to the distribution management server.
http://streaminng.tv/ . . . / . . . /index.php? ch=001 (1)

Further, when an image is to be distributed to a specified viewer, the address of the distribution management server 3 and an image identification code inputted by the viewer, as indicated in the following expression (2), will be embedded in the HTML language, and the data related to the inputted image identification code h3 will be transmitted to the distribution management server 3. The following expression (2) indicates that an image identification code “123456789012” will be transmitted to the distribution management server 3.
http://streaminng.tv/ . . . / . . . /index. php?code=123456789012 (2)

Therefore, the distribution management program 3a6 can analyze whether a request data transmitted from the reception terminal apparatuses 1a, 1b, . . . is a distribution request based on a channel number (ch), or a distribution request based on an image identification code.

(Step S12)

By processing in Step S12, when a distribution request is a request based on a channel number h1, the program proceeds to Steps S19-S21 and S17. On the other hand, if there is a distribution request based on an image identification code h3, the program proceeds to Steps S13-S17. Further, when it is determined that a distribution request is a request based on those other than channel number h1 or image identification code h3, the program proceeds to Step S18, so that an error message is transmitted to a reception terminal apparatus which has requested the distribution, thereby ending the processing of the distribution management program 3a6.

(Step S13) (Step S14)

When it is determined at Step S13 that a distribution request is a request based on an image identification code h3, the distribution management program 3a6 proceeds to Step S14, so as to check whether the received image identification code h3 has been in advance registered in the distribution management data table T1a. If the received image identification code h3 has been registered in the distribution management data table T1a, the program proceeds to Step S15. On the other hand, if the received image identification code h3 has not been registered in the distribution management data table T1a, the program proceeds to Step S18, so that a message such as “input error” or the like is transmitted to a reception terminal apparatus which has requested the distribution, thus ending the processing of the distribution management program 3a6.

(Step S15)

As to the received image identification code h3, reference is made to the distribution management data table T1a to check the data of the distribution period h4 during which the received image identification code is registered. Actually, such a checking is performed to check whether the date and hour at which a distribution request was received from the reception terminal apparatuses 1a, 1b, . . . is contained in the distribution period h4 of the distribution management data table T1a. The reason for checking this distribution period h4 is because there is a contract which has set up a streaming image distribution period required by a distribution requestor. At Step S15, if a predetermined distribution period is over or if the predetermined period is earlier than today, it can be determined that a distribution request has been received showing that a distribution period is not proper, so that the program proceeds to Step S18, and an error message showing that the distribution period is not proper is transmitted to a reception terminal apparatus having requested such distribution, thereby ending the processing of the distribution management program 3a6.

(Step S16)

If, at Step S15, a distribution period has been found proper, reference will be made to the distribution management data table T1a so as to find the addresses (URL) of the image distribution servers 4a, 4b, . . . and a file name h6 of a streaming image, with each server and each file name containing an image identification code h3 set therein.

(Step S17)

In Step S16, once the program finds a file name h6 of a streaming image in which an image identification code h3 has been inputted, as well the URLs of the image distribution servers 4a, 4b, . . . storing the streaming image, the distribution management program 3a6 will perform a control for distributing the streaming image to the reception terminal apparatuses 1a, 1b, . . . which have sent distribution requests to the image distribution servers. In this way, while receiving the streaming image requested for distribution, the reception terminal apparatuses 1a, 1b, . . . will allow viewers to view the received streaming image.

(Step S19)

If, in Step S12, it is determined that a distribution request is a request based on a channel number h1, the distribution management program 3a6 will check whether a received channel number h1 has been in advance registered in the distribution management data table T1a. If the received channel number h1 has been registered in the distribution management data table T1a, the program proceeds to Step S20. On the other hand, if a received channel number h1 has not been registered in the distribution management data table T1a, the program proceeds to Step S18, so that a messages such as “input error” is transmitted to a reception terminal apparatus which has issued a distribution request, hence ending the processing of the distribution management program 3a6.

(Step S20)

As to a received channel number h1, reference is made to the distribution management data table T1a to check the data of the distribution period h4 which is provided with the received channel number. Actually, such a checking is performed to check whether the date and hour at which a distribution request was received from the reception terminal apparatuses 1a, 1b, . . . is contained in the distribution period h4 of the distribution management data table T1a. As in the above Step S15, the reason for checking this distribution period is because there is a contract which has set up a streaming image distribution period h4 required by a distribution requestor. At Step S20, if a distribution request has been received showing that a distribution period is not proper, the program proceeds to Step S18, and an error message showing that the distribution period is not proper is transmitted to a reception terminal apparatus having requested such distribution, thereby ending the processing of the distribution management program 3a6.

However, in the processing of Step S20, since there is a possibility that a plurality of image file names h6 having different distribution periods h4 are registered in one channel number h1, a processing will be performed to check all the distribution periods h4 of image file names h6 or the like having an identical channel number h1 set therein.

(Step S21)

If it is determined in Step S20 that a distribution period is appropriate, reference will be made to the distribution management data table T1a to find the addresses (URL) of the image distribution servers 4a, 4b, . . . having channel numbers set therein, and to find file names of streaming images having channel numbers set therein and appropriate distribution periods. Upon proceeding to Step S17, the distribution management program 3a6 performs a control of distributing a streaming image having a file name h6 and having a channel number h1 set therein to the reception terminal apparatuses 1a, 1b, . . . which have sent out distribution requests to the image distribution servers.

In the above-mentioned processing of the distribution management server 3, the processing of Step S12, Steps S19-S21, and Step S17 constitutes first streaming image distribution means of the present invention. Similarly, the processing of Steps S13-S17 constitutes second streaming image distribution means of the present invention.

According to the above-described embodiment of the present invention, in order for a viewer to input an image identification code h3 to request a distribution, it is allowed to use not only the method of transmitting the image identification code input form T2 shown in FIG. 3 to the distribution management server 3 by means of HTML mail, and the method of performing the same transmission to the distribution management server 3 using the web page T4 shown in FIG. 5, but also the following method 1) and method 2).

1) Means is provided which can download, from a distribution requestor's web page, a form shown in FIG. 3 or FIG. 5 for inputting an image identification code h3, to viewer's reception terminal apparatuses 1a, 1b, . . . , so that viewers can store the downloaded input form in the external storage devices of the reception terminal apparatuses 1a, 1b, . . . . Then, when a distribution is requested, the input form is displayed on a screen and an image identification code h3 is inputted so as to be transmitted to the distribution management server 3. At this time, the input form is produced in HTML language, while the address of the distribution management server 3 is embedded in this language.

2) A distribution proprietor records the above-described form for inputting an image identification code h3 in a recording medium such as CD-ROM or the like. Then, the distribution proprietor supplies the CD-ROM to a distribution requestor. Subsequently, the distribution requestor distributes the CD-ROM to a specified viewer. When the viewer having received the CD-ROM requests a distribution, the CD-ROM is read from a reception terminal apparatus and the input form is displayed on a screen, so that the inputted image identification code h3 can be transmitted to the distribution management server 3. At this time, the input form is made in HTML language, while the address of the distribution management server 3 is embedded in this language.

As described above, the streaming image distribution system of the present invention, by referring to the distribution management table T1a registered in advance in the distribution management server 3, can distribute a streaming image appropriately, irrespective of whether the streaming image is to be distributed to many and unspecified viewers or to be distributed to some specified viewers. In particular, when a streaming image is to be distributed to a specified individual person, since a distribution requesting is performed by inputting an image identification code, it is possible to ensure a desired security for an image to be distributed. Moreover, although a streaming image to be distributed has a predetermined period for distribution, since, at the time of distribution, the data of the distribution period registered in advance in the distribution management data table T1a is checked before distribution, it is possible to prevent the distribution of an image whose distribution period has already passed or is not due.

As to the above-discussed streaming image distribution system of the present invention, although the description has described an example in which the data of streaming images stored in the image distribution servers 3a, 4a, and 4b are uploaded by a distribution proprietor, the present invention also makes it possible to establish a system in which the streaming images requested to be distributed by a distribution requestor can be uploaded to the distribution management server 3 or the image distribution servers 4a, 4b, . . . . In this case, it is allowed to employ the following methods.

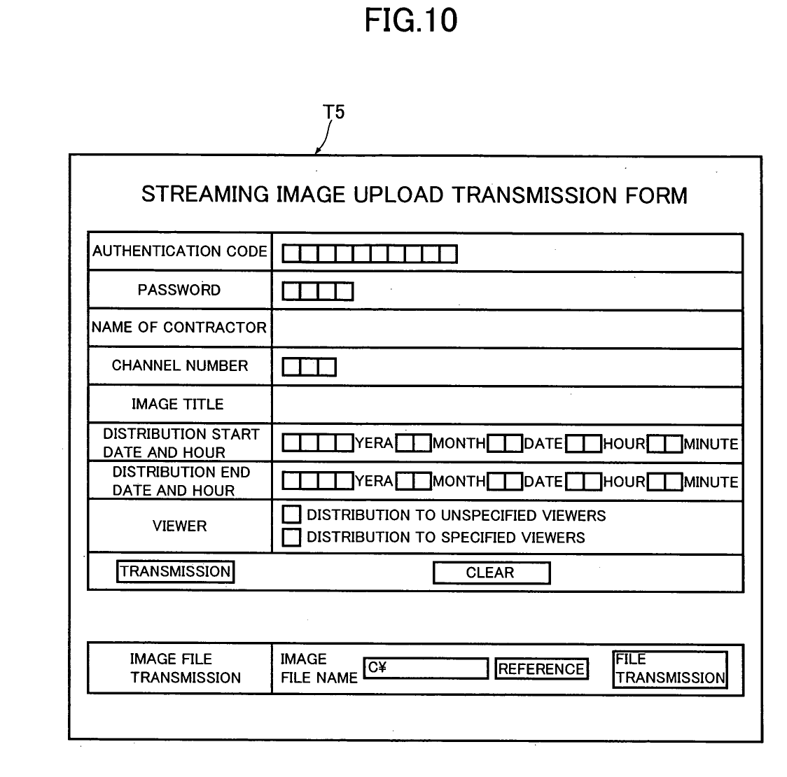

1) At first, a distribution proprietor provides a distribution request or with a recording medium such as CD-ROM storing a streaming image upload transmission form T5 prepared in the HTML language and shown in FIG. 10. Actually, such recording medium also stores a software for converting dynamic image into streaming image to be distributed, as well as an upload software (FTP) or the like.

2) After a dynamic image picked up by a distribution requestor itself is converted to a streaming image to be distributed, and when the streaming image is uploaded to the image distribution servers 4a, 4b, . . . , it is allowed to use a personal computer connected to the Internet 6 to display on the computer screen a streaming image upload transmission form T5 shown in FIG. 10.

3) Then, a distribution requestor inputs necessary data in the streaming image upload transmission form T5, such as a distribution requestor's authorization code, a password, a channel number, the title of an image, and distribution start date and hour, distribution end date and hour, as well as designations as to whether viewers should be many and unspecified persons or specified persons. However, a channel number to be inputted is a channel number set in advance to the distribution requester.

4) Subsequently, a distribution requestor attaches a file of a streaming image (for distribution) to the streaming image upload transmission form T5 and transmits them to the distribution management server 3.

5) Once the distribution management server 3 receives the above-mentioned streaming image upload transmission form T5 and the streaming image data for distribution, the streaming image registration program 3a8 will operate to check whether the received distribution requestor's authorization code and the password have been in advance registered.

6) If the received distribution requestor's authorization code and password have already been registered, the streaming image registration program 3a8 will determine that the present operation is a normal upload operation from the distribution requestor, thereby registering the received data items such as a channel number, an image title, a distribution period, an image file name, and the like into the distribution management data table T1a. Moreover, as to which image distribution server should be used to register the received streaming image data, can be decided in the following manner. Namely, the received data will be dealt with according to a predetermined order of priority, such that if there has already been an image distribution server in which the distribution requestor's streaming image has already been registered, such received data will be registered in the address of this image distribution server.

7) If a streaming image to be uploaded by a distribution requestor is distributed to a specified viewer, and when an address of an image distribution server to which a streaming image is uploaded has been determined, the streaming image registration program 3a8 will operate to automatically set an image identification code by using random number generation means. The image identification code thus set is then registered in an area h3 which records an image identification code corresponding to the received channel number h1 of the distribution management data table T1a.

8) By virtue of the above processing, since the URL of an image distribution server which accumulates the streaming image transmitted to the distribution management server 3 has been decided, the streaming image registration program 3a8 will automatically upload the image data to the image distribution server.

9) Once the processing of the above 8) is ended, an e-mail indicating the end of the upload registration processing is transmitted to the distribution requester, thereby completing the upload processing of the distribution requester.

Then, description will be given to explain another embodiment of distribution request transmission means based on a channel number. In order to carry out this embodiment, it is necessary for a distribution requestor to perform the following processing.

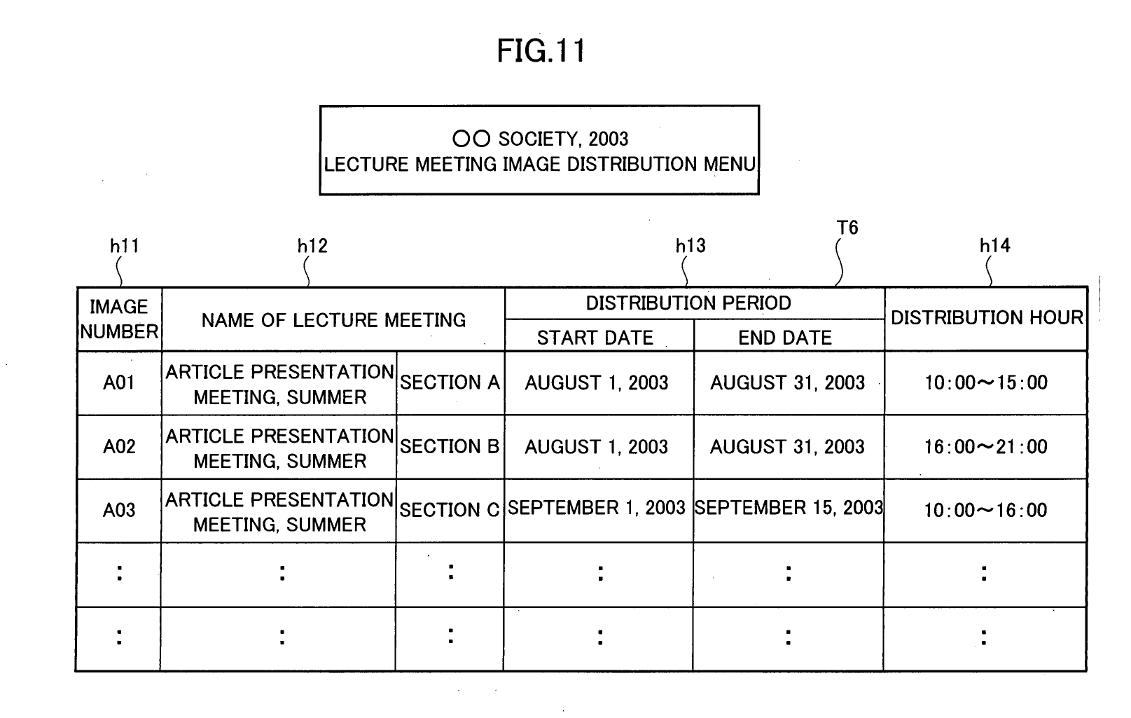

1) web servers 2a, . . . are used to exhibit a web page on the Internet 6. This web page allows a viewer to peruse a distribution menu T6 of dynamic image data to be distributed, as shown in FIG. 11. Then, this allows a viewer having perused the web page to transmit a streaming image distribution request by using the reception terminal apparatuses 1a, . . . . Here, as the display contents of the distribution menu T6, it is possible to display, as shown in FIG. 11, an image number h11 of a dynamic image to be distributed, an image name h12, a period (distribution period) h13 for distributing a dynamic image, a time zone (distribution time zone) h14 for distributing the dynamic image.

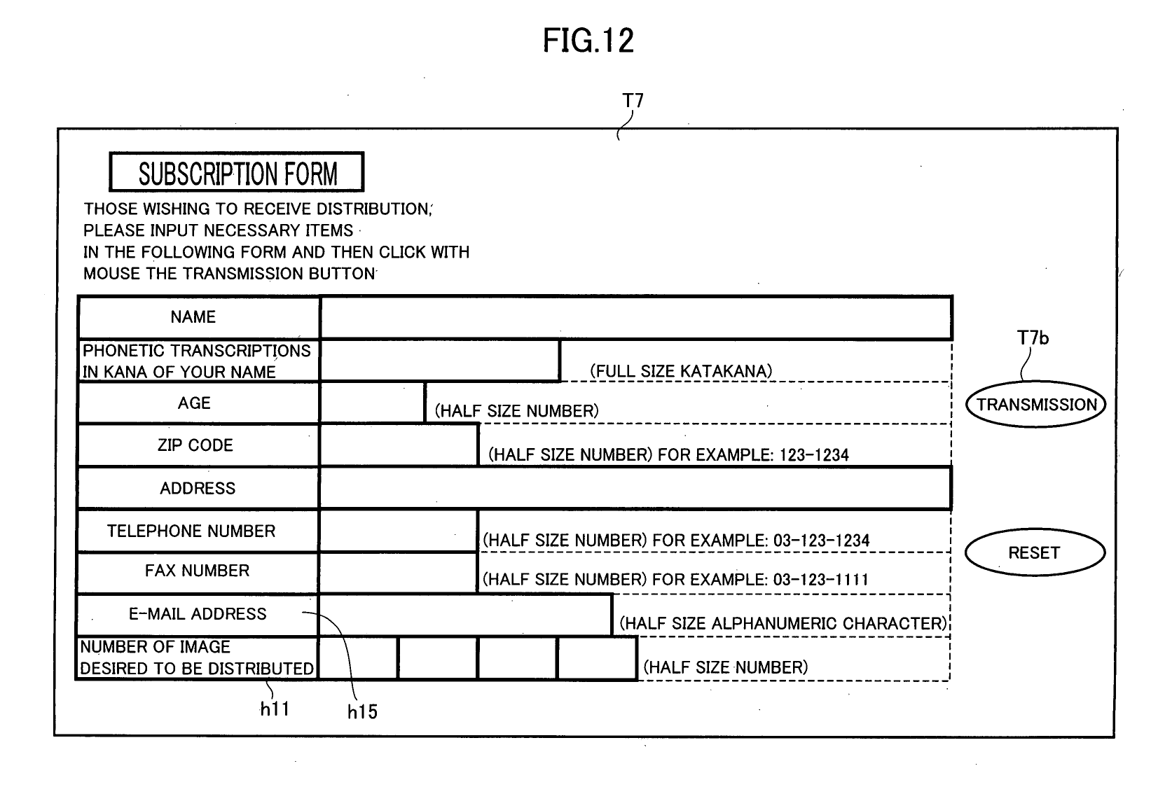

2) When a viewer having perused this web page using the reception terminal apparatuses 1a, . . . wishes to request the distribution of the dynamic image, the viewer can input some necessary items in a subscription form T7 displayed on the web page, as shown in FIG. 12, and then transmit the same to the web servers 2a, . . . . The items to be inputted in the subscription form T7 include, as shown in FIG. 12, a subscriber's name, address, e-mail address h15, and an image number h11 requesting a distribution and selected from the image numbers shown in menu T6. In this way, a series of processing for exhibiting a web page on the Internet, receiving a distribution request from a user through the web page, and preparing a list of subscribers can all be completed by using HTML which is a language describing a web page, and CGI (Common Gateway Interface) language.

3) A distribution requestor, upon receiving a dynamic image data distribution subscription from a viewer through the Internet 6, charges the viewer (an actual user having sent out the subscription) for the distribution service if the distribution of the dynamic image data is not free of charge. In fact, the charging of the distribution fee may be effected through mail or e-mail, or through the well-known Internet mail order system, using the above-mentioned web page to request a banking payment of the distribution fee.

4) The distribution requester, upon confirming the payment of the distribution fee performed by the viewer, informs an image distribution proprietor of the viewer's e-mail address and an image number (h11 shown in FIG. 11) having requested the distribution. Such information can be transmitted via e-mail to the e-mail address of the image distribution proprietor.

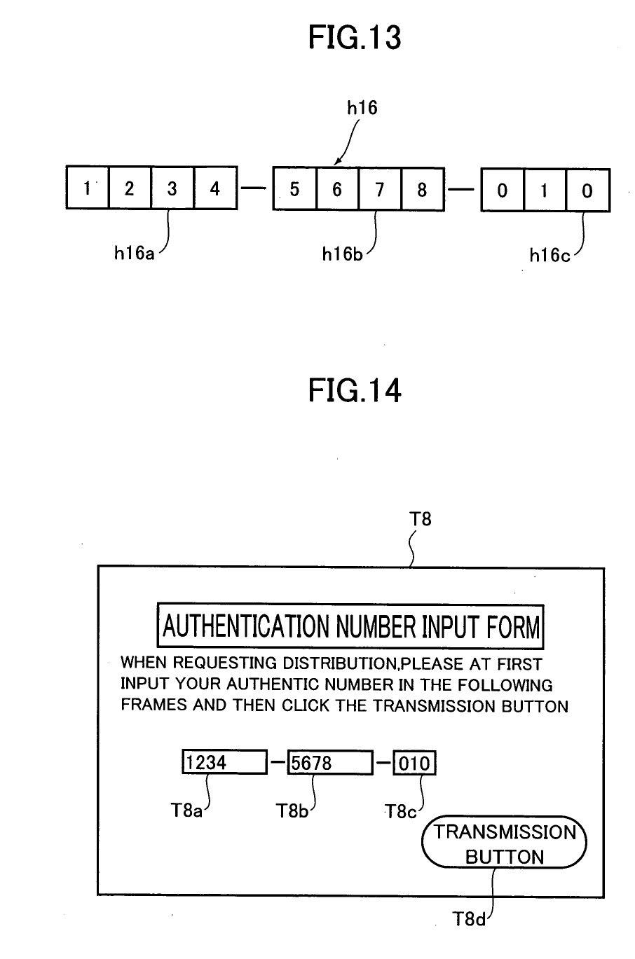

5) The image distribution proprietor, upon receiving the viewer's e-mail address and an image number having requested the distribution, prepares, for example, an authentication number h16 having a data composition as shown in FIG. 13, and informs the distribution requestor of this authentication number h16. Actually, such information may be transmitted via e-mail to the e-mail address of the distribution requestor. The authentication number h16 shown in FIG. 13 is composed of a first 4-digit number portion h16b, a second 4-digit number portion h16b, and a third 3-digit number portion 16c, thus forming 11 digits in all. The first number portion 16a and the second number portion h16b represent affiliate numbers provided by the distribution requestor, or numbers provided by the distribution requestor or the image distribution proprietor for identifying respective viewers. The third number portion h16c indicates a channel number h1. In addition, the numbers of digits of the first number portion h16a, the second number portion h16b, and the third number portion h16c indicating a channel number h1, can be arbitrarily set up according to the scale of the system, while the contents of respective digits may be formed not only by Arabic numbers but also by alphanumeric characters containing alphabetic characters. In fact, the present embodiment is characterized in that the authentication number h16 used by a viewer when requesting the distribution of a streaming image is composed of an inherent number for identifying each viewer and a sort of data containing a channel number h1. Further, an arrangement of the respective number portions h16a, h16b, and h16c may be set in advance with an appropriate order.

6) The distribution requestor, upon receiving an authentication number h16 from the image distribution proprietor, informs a viewer having requested the distribution of the streaming image of this authentication number h16. In practice, such information may be transmitted via mail or e-mail. However, when a viewer operates the reception terminal apparatuses 1a, . . . to send out a dynamic image data distribution request, such an operation is preferred to be as simple as possible. As a method for achieving such an object, the distribution requestor or the image distribution proprietor is allowed to transmit, via HTML mail, an authentication number input form T8 shown in FIG. 14 from the web servers 2a, . . . (or the distribution management server 3) to the e-mail addresses of the reception terminal apparatuses 1a, 1b, . . . of the users. The authentication number input form T8 is provided to display the input positions T8a, T8b, and T8c of the first number portion h16a, the second number portion h16b, and the third number portion (channel number h1) of the authentication number h16, with the authentication number input form T8 itself being formed in HTML language. Moreover, in such an HTML language constituting this authentication number input form T8 there is embedded the address (URL) of the distribution management server 3. Then, when a viewer requests the distribution of a streaming image, the authentication number input form T8 is displayed on the reception terminal apparatuses 1a, . . . , followed by inputting his or her own authentication number h16 in the predetermined areas T8a, T8b, and T8c. Subsequently, upon clicking with mouse the transmission button T8d, the inputted data is transmitted to the distribution management server 3.

Next, description will be given to explain the summery of a processing to be performed when the distribution management server has received via HTML mail a streaming image distribution request, i.e., a recognition number 9 from the reception terminal apparatuses 1a, . . . .

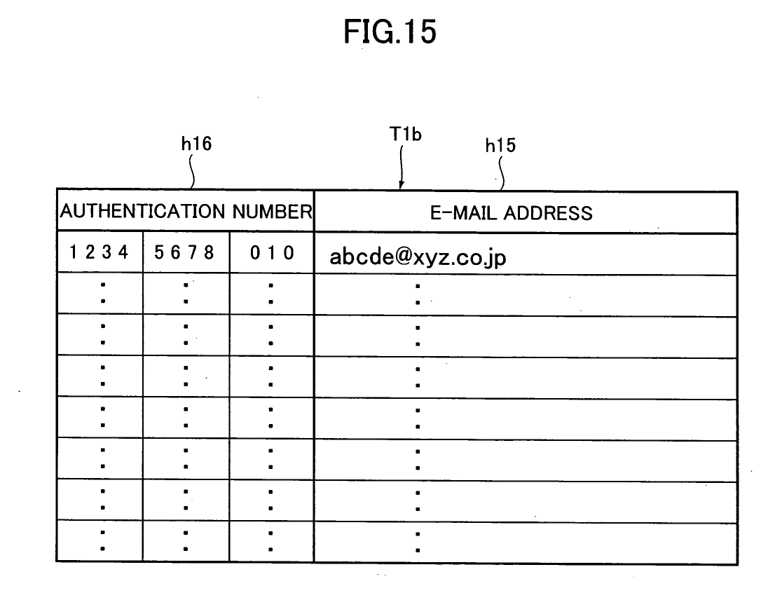

1) An authentication number management table T1b shown in FIG. 15 is read into an internal storage device. Next, after a received 11-digit authentication number h16 is stored into the internal storage device, checking is performed to check whether the authentication number h16 stored in the internal storage device has been registered in the authentication number data table T1b. As a result of this checking, if it is found that the received authentication number h16 is not registered in the authentication number data table T1b, an e-mail indicating “an input error of the authentication number” or the like is transmitted to the reception terminal apparatuses 1a, . . . having requested the distribution. In fact, such an e-mail transmission may be performed by making reference to the address of HTML mail received from the reception terminal apparatus. On the other hand, if the received authentication number h16 is registered in the authentication number data table T1b, the following processing 2) will be performed. Here, the authentication number data table T1b is a database which has stored the mail addresses of distribution requestors for respective authentication numbers h16.

2) As to a requested streaming image, retrieval processing is performed to search for the image distribution server 3a, . . . storing the image data, and also to search for the web servers 4a, 4b, . . . as well as their file names, using as a key a channel number h16c contained in the authentication number h16 transmitted from the reception terminal apparatuses 1a, 1b, . . . . Such retrieval processing is carried out by making reference to the distribution management data table T1a, and checking whether the channel number contained in the received authentication number h16 is registered in the distribution management data table T1a. In such retrieval processing, once the data of the same value as the channel number (h16c) contained in the received authentication number h16 are found from the column h1 of the channel numbers of the distribution management data table T1a, URL h5 and the file name h6 of the image distribution server registered as attribute item data of this channel number will correspond to the data of the streaming image whose distribution has been requested. In this way, the distribution management program 3a6 can distribute the streaming image requested based on the authentication number h16 for distribution, to the reception terminal apparatus on viewer's side.

While there has been described what are at present considered to be preferred embodiments of the present invention, it will be understood that various modifications may be made thereto, and it is intended that the appended claims cover all such modifications as fall within the true spirit and scope of the invention.

1. A streaming image distribution system comprising:
image distribution servers storing streaming images to be requested for distribution;
a distribution management server having a distribution management data table containing, through registration, channel numbers set for respective distribution requesters requesting distribution of the streaming images, file names related to the streaming images to be distributed for respective channel numbers, distribution periods, addresses of the image distribution servers storing the streaming images; and
reception terminal apparatuses of viewers for requesting distribution of the streaming images and viewing the streaming images,
wherein the distribution management data table has included, through registration, image identification codes for performing transmission from the reception terminal apparatuses to the distribution management server, in a manner such that only specified viewers can request distribution of streaming images provided with the channel numbers,
wherein the reception terminal apparatuses are provided with distribution request transmission means which, in requesting distribution of the streaming images, transmits the channel number or image identification code to the distribution management server.

2. The streaming image distribution system according to claim 1, wherein the distribution request transmission means is means for transmitting the channel number or the image identification code to the distribution management server through a web page disclosed by the distribution requestor or a proprietor of the distribution management server.

3. The streaming image distribution system according to claim 1, wherein the distribution request transmission means is means for transmitting the channel number or the image identification code by HTML mail to the distribution management server.

4. The streaming image distribution system according to claim 1, wherein the distribution request transmission means is means for transmitting a recognition number, consisting of an identification number for identifying a viewer and a channel number, to the distribution management server, through a web page disclosed by the distribution requestor or a proprietor of the distribution management server.

5. The streaming image distribution system according to claim 4, wherein the distribution request transmission means is means for transmitting a recognition number, consisting of an identification number for identifying a viewer and a channel number, to the distribution management server, by means of HTML mail.

6. The streaming image distribution system according to claim 1, wherein the distribution management server comprises:
first streaming image distribution means which, upon receiving a channel number from the distribution request transmission means of the reception terminal apparatus, refers to data within the distribution period registered in the distribution management data table about the received channel number, finds the file name of a streaming image where a date on which the distribution request was received is contained in the distribution period, also finds the address of the image distribution server, and performs a control on the image distribution server for distributing a streaming image provided with the file name to the reception terminal apparatus; and
second streaming image distribution means which, upon receiving an image identification code from the reception terminal apparatus, refers to data within the distribution period registered in the distribution management data table about the received image identification code, finds the file name of a streaming image where a date at which the image identification code was received is contained in the distribution period, also finds the address of the image distribution server, and performs a control on the image distribution server for distributing a streaming image provided with the file name to the reception terminal apparatus.

7. The streaming image distribution system according to claim 1, further comprising a terminal apparatus of the distribution requester, which apparatus includes means for uploading to the distribution management server a streaming image requested by the distribution requestor for distribution.

8. The streaming image distribution system according to claim 1, wherein the proprietor of the distribution management server is a system which rents the channel number to the distribution requestor.
